(19) United States
(12) Patent Application Publication
(10) Pub. No.: US 2002/0023047 A1
(43) Pub. Date: Feb. 21, 2002

(54) Financing commercial product trading method

(76) Inventor: Akihiko Noju, Saitama (JP)

Correspondence Address: RABIN & CHAMPAGNE, PC, 1101 14TH STREET, NW, SUITE 500, WASHINGTON, DC, 20005, US

(21) Appl. No.: 09/873,306

(22) Filed: Jun. 5, 2001

(30) Foreign Application Priority Data
Aug. 16, 2000 (JP) 246765/2000

(51) Int. Cl. G06F 17/60

(52) U.S. Cl. 705/37; 705/27

(57) ABSTRACT

A financing commercial product trading method of the present invention is a method for trading a financing product for trading the financing product to a client by way of a network, and includes a transmitting step for transmitting picture image information, which contains explanatory sentences for explaining a possibility of taking place a disadvantageous condition, to a client corresponding to a request from the client and also for transmitting guiding information, which guides an operation which should process an acknowledgement of the client about the possibility of taking place the disadvantageous condition by an intervention of a third party institution; a confirmation step for confirming the acknowledgement of the client by way of the third party institution; and an operation proceeding step for proceeding a trade of a financing commercial product with the client after the acknowledgement is confirmed.

### BACKGROUND OF THE INVENTION

1. Field of the Invention

The present invention relates to a method of trading a financing product by way of a network and a system thereof.

2. Description of the Related Art

In recent years, a commercial product trade and a commercial product trade system, which have utilized a network, have been spread out throughout the world, since the network represented by the Internet has been widely spread out rapidly, devices utilizing the networks have come to be cheaper, and the cost for telecommunication has come to be low. The commercial products, which have been traded, range from products such as books and clothes traded in a general small store to the financing commercial products such as loan bonds, trusts, insurance, and securities. In the case of the financing commercial products, conventionally, the financial institution such as a bank and a stock brokerage firm has given an account and traded based on a style of interviewing by a business person at a store or by calling on the client. For the reason thereof, since the financing commercial products hold the possibility of causing a disadvantageous situation to a purchaser because of falling below par value due to a fluctuation of the interest rate and a fluctuation of exchange, a loan bond market, and the like as the characteristics thereof, it is required to achieve sufficient understanding to the possibility thereof by explaining whether or not it exists and by explaining the factors to the client. For example, for trading an investment trust, it is regulated by the securities exchange law to protect the client as an investor by proposing a schematic idea reciting a practicing plan. In this way, the possibility of causing such a disadvantageous situation should be explained to the purchaser by a trader as an important issue explanation for the financing commercial product trade.

At this point, for selling the financing commercial products by way of the network, it is general to perform the explanation of a risk of the fluctuation of the interest rate and a risk of falling below par value by a method such as displaying information contents and a voice response. Though, for trading the products through the network, it is performed to recognize that the financial institution and the client are right institutions and people in accordance with each of recognizing methods utilizing the security technology; there has not existed, however, a method for verifying that the financial institutions have explained sufficiently and accurately the important issues such as risks of the fluctuation of the interest rate and falling below par value to the client group and the client group has received and understood them sufficiently and accurately.

### SUMMARY OF THE INVENTION

Therefore, it is an object of the present invention to provide a financing commercial product trading method which overcomes the above issues in the related art. This object is achieved by combinations described in the independent claims. The dependent claims define further advantageous and exemplary combinations of the present invention.

The object of the present invention is to provide a method for trading a financing commercial product, which is capable of verifying that the trader of the financing commercial product has made such an explanation sufficiently to the client and the above-mentioned customer has understood the above-mentioned explanation sufficiently, for the explanation of the financing commercial product in the same manner as the explanation of the important issue for the financing commercial product trade by way of the network.

The financing commercial product trading method of the present invention is the financing commercial product trading method for trading the financing commercial products to the client by way of a network is characterized in that the method thereof includes a transmitting step for transmitting picture image information, which contains explanatory sentences for explaining a possibility of taking place a disadvantageous condition, to a client corresponding to a request from the client and also for transmitting guiding information, which guides an operation which should process an acknowledgement of the client about the possibility of taking place the disadvantageous condition by an intervention of a third party institution; a confirmation step for confirming the acknowledgement of the client by way of the third party institution; and an operation proceeding step for proceeding a trade of a financing commercial product with the client after the acknowledgement is confirmed.

The intervention of the third party institution is made possible by an intervention of a notification of an acknowledgement of the client by the third party institution.

The intervention of the third party institution of the confirmation step contains that the third party institution explains about the possibility of taking place a disadvantageous condition to the client.

The intervention of the third party institution of the confirmation step further contains the intervention of an enquiry from the client by the third party institution.

The intervention of the third party institution of the confirmation step further contains the intervention of answering an enquiry from the client to the client.

A financing commercial product trading system of the present invention includes a financing commercial product trading server for outputting results of searching stock items of financing commercial products from financial product information contents; a third party institutional server for inquiring important issue interpretation contents about financing commercial products, for recognizing and recording them, and for issuing a charge statement of a price to the financing commercial product trading server; and a client terminal having a Web browsing function.

This summary of the invention does not necessarily describe all necessary features of the present invention. The present invention may also be a sub-combination of the above described features. The above and other features and advantages of the present invention will become more apparent from the following description of embodiments taken in conjunction with the accompanying drawings.

### BRIEF DESCRIPTION OF THE DRAWINGS

FIG. 1 is a network which includes a financing commercial product trading system of the embodiment of the present invention.

FIG. 2 is a flowchart of operational processes of the present embodiment.

FIG. 3 illustrates an explanatory picture image of the financing commercial product of the present embodiment.

### DETAILED DESCRIPTION OF THE INVENTION

The invention will now be described based on the preferred embodiments, which do not intend to limit the scope of the present invention, but exemplify the invention. All of the features and the combinations thereof described in the embodiments are not necessarily essential to the invention.

In the following, the preferred embodiment of the present invention is explained with reference to the drawings.

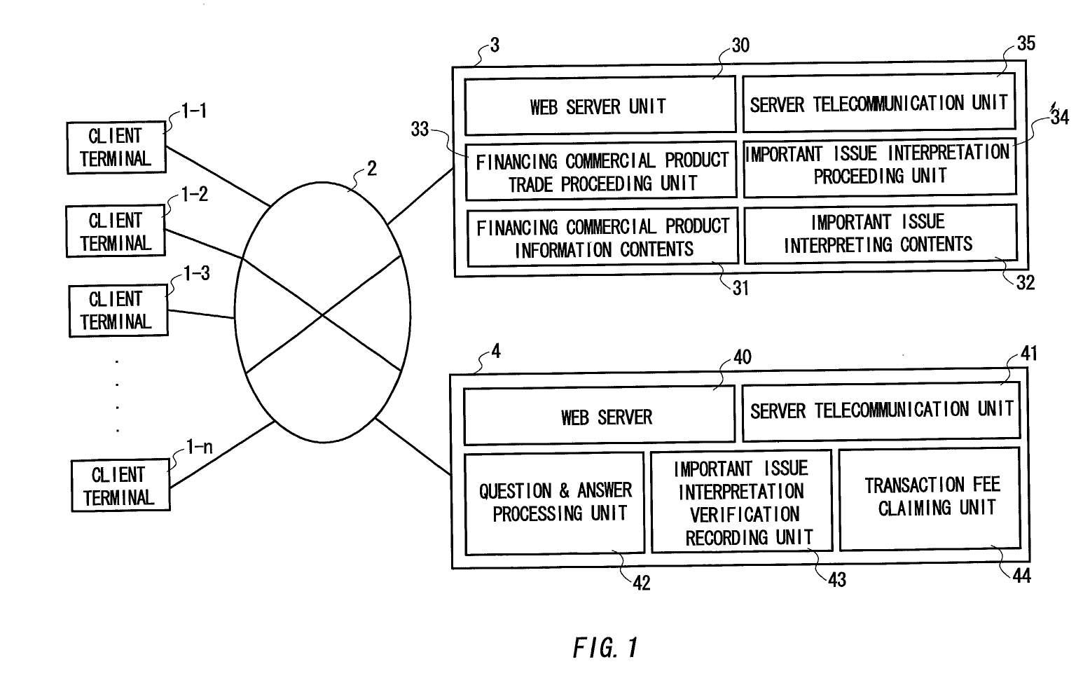

FIG. 1 is an embodiment of the present invention, and is a network which includes a financing commercial product trading server. The embodiment is an example of the banking commercial product trade under a Web environment using the Internet.

In FIG. 1, n (n is a positive integer) customer terminals 1-1 to 1-n, a financing commercial product trading server 3 of a financial institution, and the third party institution server 4 are connected to the Internet 2. The third party institution for operating the third party financial institution system is an organization for acknowledging publicly the act of transmitting important information requiring the act of verifying legally, and is an institution independent from the financial institution or a customer of a financing commercial product.

Client terminals 1-1 to 1-n are conventional personal computers, and include respective Web browsing functions. The financing commercial product trading server 3 is a server computer, and includes a Web server unit 30, a server telecommunication unit 35, a financing commercial product trade proceeding unit 33, an important issue interpretation proceeding unit 34, financing commercial product information contents 31, and important issue interpreting contents 32. The financing commercial product trading server 3 is a server computer, and includes the Web server unit 30, the server telecommunication unit 35, the financing commercial product trade proceeding unit 33, the important issue interpretation proceeding unit 34, the financing commercial product information contents 31, and the important issue interpreting contents 32. The server telecommunication unit 35 telecommunicates with the third party institution server 4 by transmitting and receiving data and a control command indicating URL (Uniform Resource Locator) of the third party institution server 4. This control command is a command based on HTTP (Hypertext Transport Protocol), and is such a command as GET/PUT, for example.

The third party institution server 4 is a server computer, and is composed of a Web server 40, a server telecommunication unit 41, a question & answer processing unit 42, an important issue interpretation verification recording unit 43, and a transaction fee claiming unit 44. The server telecommunication unit 41 is the same as the server telecommunication unit 35, and telecommunicates with the financing commercial product trading server 3 by transmitting and receiving a command indicating URL of the financing commercial product trading server 3.

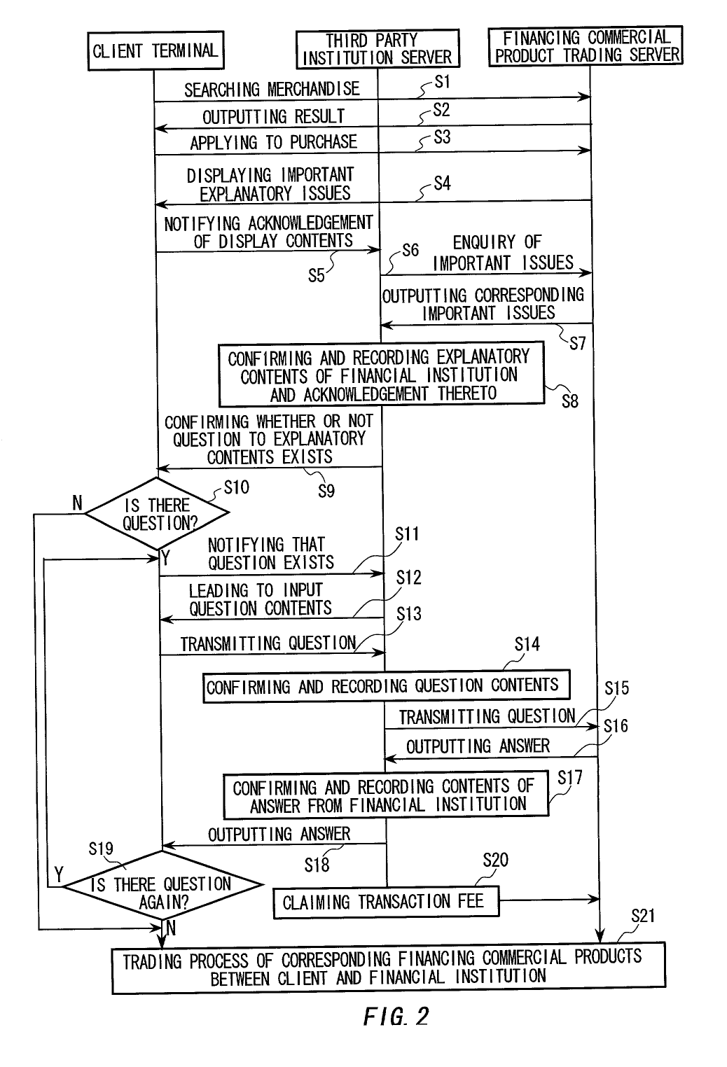

FIG. 2 is a flowchart of operational processes in which a client terminal 1-1, the third party institutional server 4, and the financing commercial product trading server 3 cooperate with each other and then it is obtained to record a transmission acknowledgement.

First of all, the client performs an act of searching about a stock condition of financial trade products to the financing commercial product trading server 3 by way of the network 2 by operating the client terminal 1-1 (a step S1). The Web server unit 30 of the financing commercial product trading server 3 outputs the results of searching the stock items of the financing commercial products to the client terminal 1-1 from the financing commercial product information contents 31 (a step S2). The client notifies the will of purchasing to the financing commercial product trading server 3 byway of the client terminal 1-1 if there exists a product which is required to purchase (a Step S3).

The important issue interpretation proceeding unit 34 of the financing commercial product trading server 3 which has received the notification of the act of exercising the will to purchase outputs an important issue which requires an explanation to the client when the above-mentioned financing commercial products are sold (a Step S4).

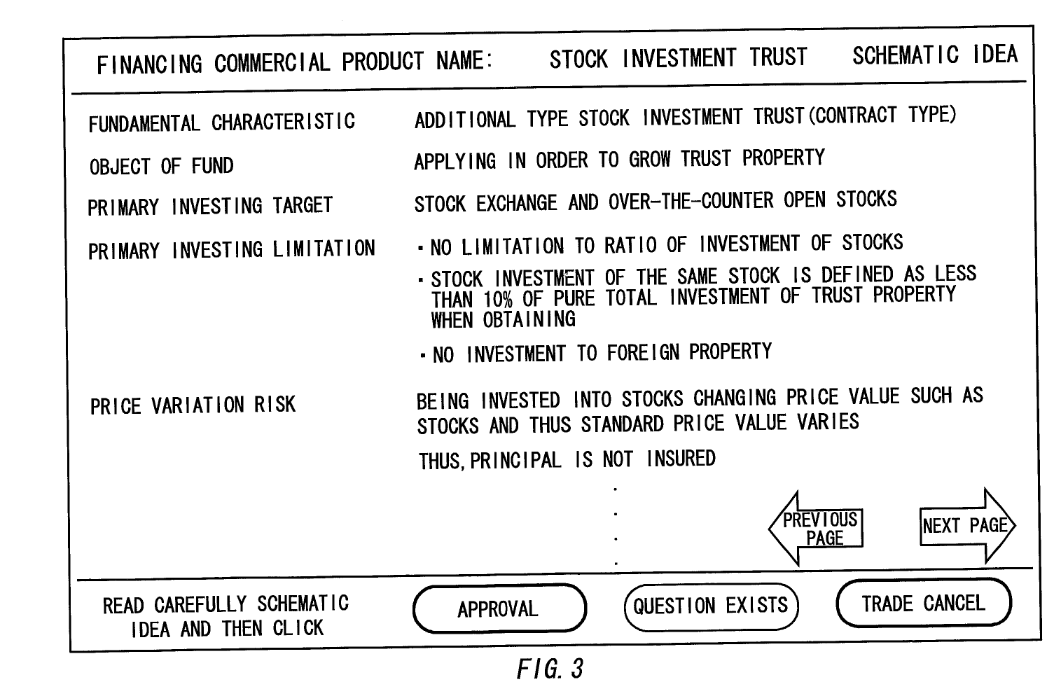

The important issue interpretation proceeding unit 34 of the financing commercial product trading server 3, which has received the notification of the act of exercising the will to purchase, outputs an important issue, which requires the explanation to the client when the above-mentioned financing commercial products are sold out, to the client terminal 1-1 (a Step S4). When the client indicates a notification for the verification in which the important issues have been displayed normally to the client terminal 1-1 and then the contents thereof have been acknowledged, the client terminal 1-1 transmits the notification of the acknowledgement to the client terminal 1-1 (a Step S5). This type of operation is performed by clicking an approval button while the important issues are displayed, which are performed by the financing commercial product trading server 3. FIG. 3 shows the case in which a click operation cannot be performed if the full text of the important issue interpretation, which the financing commercial product trading server 3 of the present embodiment outputs, is not displayed. Further, URL of the third party institutional server 4 is embedded in a displayed page of the financing commercial product trading server, and thus it is not required for the client to be conscious.

In accordance with the notification of this approval, the question & answer processing unit 42 of the third party institutional server 4 inquires of the important issue interpretation contents about the above-mentioned financing commercial product for the financing commercial product trading server 3 (a Step S6). Further, the important issue interpretation proceeding unit 34 of the financing commercial product trading server 3 transmits the important issue contents by way of the server telecommunication unit 35 from the important issue interpreting contents 32 (a Step S7). Further, the important issue interpretation verification recording unit 43 of the third party institutional server 4 recognizes and records the contents the above-mentioned important issue interpretation, which has been received, and the notification of the client thereto (a Step S8). At this time, for performing a verifying and recording process, it is possible to include not only a recording process of the above-mentioned explained contents, but also a process for an eye inspection by an operator to the third party institutional server 4, for example, a displaying process by a display unit. Further, it may be possible to make it possible to explain the typical contents by an AI (Artificial Intelligence) process including a semantic analysis and a syntactic analysis by the computer.

Then, the question & answer processing unit 42 makes requests to ask whether or not the question exists to the important issue interpretation contents to the client terminal 1-1 (a Step S9), and then determines whether or not there is a question of the customer (a Step S10). When there is no question, a merchandise operating process at the Step 21 is performed. When there is any question, the client terminal 1-1 notifies to the financing commercial product trading server 3 that the question has existed (at Step S11). In accordance with this notification, the question & answer processing unit 42 transmits a picture image or a promoting message for promoting the client to input the contents of the question (a Step S12). The client operates the client terminal 1-1 and then transmits the question to the financing commercial product trading server 3 in accordance with the picture image or the above-mentioned promoting messages (a Step S31). The important issue interpretation verification recording unit 43 of the financing commercial product trading server 3 verifies and records the contents of the question of the client (a Step S14). Then, the above-mentioned question is transmitted to the financing commercial product trading server 3 (a Step S15).

The important issue interpretation proceeding unit 34 of the financing commercial product trading server 3 searches an answer to the above-mentioned questions from the important issue interpreting contents 32, and then transmits it to the third party institutional server 4 by way of the Web server unit 30 (a Step S16). The important issue interpretation verification recording unit 43 of the third party institutional server 4 verifies and records explanatory contents which have received from the financing commercial product trading server 3 (a Step S17). Further, the above-mentioned answer is transferred to the client terminal 1-1 (a Step S18).

Subsequently, the client terminal 1-1 determines whether or not the questions of the client exist once more (a Step S19). In the case where the client has the questions, the procedure is back to a process for transmitting the questions after the Step S11 and the following steps therefrom. Then, the steps S11 to S17 are repeated until the question of the client disappears. In accordance with the actual operation for verifying and recording, the transaction fee claiming unit 44 of the third party institutional server 4 issues a charge statement of a price to the financing commercial product trading server 3 (a Step S20).

When the client does not have the question, the procedure of buying and selling corresponding merchandise is performed between the client terminal 1-1 and the financing commercial product trading server 3 (a Step S21).

According to the steps described in the foregoing, in a verifying record which has been obtained, it is possible to output a document for verifying that the client has acknowledged the explanation of the important issues in accordance with the financing commercial products.

In this way, according to the financing commercial product trading method of the present invention, for trading the financing products utilizing the networks, it comes to be possible to verify that a financial institution group has explained the important issues, which may cause an disadvantageous situation such as a fluctuation of the interest rate and a risk of falling below par value, for example, to the client completely and the client group has received this explanation and also acknowledged it.

The object of the present invention is capable of verifying that the trader of the financing commercial product has made such an explanation sufficiently to the client and the above-mentioned customer has understood the above-mentioned explanation sufficiently, for the explanation of the financing commercial product in the same manner as the explanation of the important issue for the financing commercial product trade by way of the network.

The financing commercial product trading method of the present invention is capable of transmitting picture image information, which contains explanatory sentences for explaining the possibility of taking place a disadvantageous condition, to a client corresponding to a request from the client and also for transmitting guiding information, which guides an operation which should process an acknowledgement of the client about the possibility of taking place the disadvantageous condition by an intervention of a third party institution; of confirming the acknowledgement of the client by way of the third party institution; and of proceeding a trade of a financing commercial product with the client after the acknowledgement is confirmed.

The intervention of the third party institution is made possible by an intervention of a notification of an acknowledgement of the client by the third party institution.

The intervention of the third party institution is capable of containing that the third party institution explains about the possibility of taking place a disadvantageous condition to the client.

The intervention of the third party institution is capable of containing the intervention of an enquiry from the client by the third party institution.

The intervention of the third party institution is capable of containing the intervention of answering an enquiry from the client to the client.

Although the present invention has been described by way of exemplary embodiments, it should be understood that many changes and substitutions may be made by those skilled in the art without departing from the spirit and the scope of the present invention which is defined only by the appended claims.

What is claimed is:

1. A financing commercial product trading method by way of a network comprising the steps of:
a transmitting step for transmitting picture image information, which contains explanatory sentences for explaining a possibility of taking place a disadvantageous condition, to a client corresponding to a request from the client and also for transmitting guiding information, which guides an operation which should process an acknowledgement of the client about the possibility of taking place the disadvantageous condition by an intervention of a third party institution;
a confirmation step for confirming the acknowledgement of the client by way of the third party institution; and
an operation proceeding step for proceeding a trade of a financing commercial product with the client after the acknowledgement is confirmed.

2. A financing commercial product trading method as set forth in claim 1, wherein the intervention of the third party institution is made possible by an intervention of a notification of an acknowledgement of the client by the third party institution.

3. A financing commercial product trading method as set forth in claim 2, wherein the intervention of the third party institution of said confirmation step contains that the third party institution explains about said possibility of taking place a disadvantageous condition to the client.

4. A financing commercial product trading method as set forth in claim 3, wherein the intervention of the third party institution of said confirmation step further contains the intervention of an enquiry from the client by the third party institution.

5. A financing commercial product trading method as set forth in claim 4, wherein the intervention of the third party institution of said confirmation step further contains the intervention of answering an enquiry from the client to the client.

6. A financing commercial product trading system comprising:
a financing commercial product trading server for outputting results of searching stock items of financing commercial products from financial product information contents;
a third party institutional server for inquiring important issue interpretation contents about financing commercial products, for recognizing and recording them, and for issuing a charge statement of a price to said financing commercial product trading server; and
a client terminal having a Web browsing function.
